(19) United States
(12) Patent Application Publication
(10) Pub. No.: US 2011/0145971 A1
(43) Pub. Date: Jun. 23, 2011

(54) Rotationally Adjustable Display Device

(76) Inventor: Robert A. Norbert, Las Vegas, NV (US)

(21) Appl. No.: 12/643,028

(22) Filed: Dec. 21, 2009

(51) Int. Cl. A41D 3/02; B32B 7/00; A41F 9/00; A43B 5/00; A45C 3/00; A41D 27/08

(52) U.S. Cl. 2/85; 428/120; 2/93; 2/338; 36/83; 190/100; 2/244

(57) ABSTRACT

A rotationally adjustable display device is described. In some embodiments, the device invention comprises a base plate that includes an interior face, an exterior face, and a channel extending through the interior and exterior faces. The device further comprises a locking disk that includes a securing post extending substantially perpendicularly therefrom. The securing post is dimensioned to pass through the channel of the base plate. The device further includes a display element having an outer face and an inner face. A rotation selection post extending substantially perpendicularly from the inner face and has an outer surface including a series of facing surfaces and an inner channel dimensioned to accept and engage the securing post. The device further comprises a rotation selection plate. The display device is substantially rotationally immobilized when the securing post is engaged with the inner channel of the rotation selection post.

### 1 NOTICE OF COPYRIGHT

Portions of this patent application include materials that are subject to copyright protection. The copyright owner has no objection to the facsimile reproduction by anyone of the patent document itself, or of the patent application, as it appears in the files of the United States Patent and Trademark Office, but otherwise reserves all copyright rights whatsoever in such included copyrighted materials.

### 2 BACKGROUND OF THE INVENTION

### 2.1 Field of the Invention

The present invention provides manufactures and methods related to visual displays, especially, visual displays attached to clothing or fashion accessories, such as shoes, belts, hats, and the like. More particularly, the present invention provides fastening systems for attaching such visual displays to clothing and fashion accessories.

### 2.2 The Related Art

The attachment of ornamentation to clothing and “accessories”, i.e., belts, shoes, hats, straps, bags, etc., to enhance the attractiveness of, or express an aesthetic or other statement by, the wearer has been practiced for millenia. In some cases, the ornamentation functions simply as a display; in other cases, the ornamentation also provide a securing or fastening function to bring two or more elements of clothing or accessories (or both) into fastened contact.

Generally, such ornamentation is either rotationally static, i.e., the ornamentation is intended to appear in a fixed rotational position once it's affixed to an article of clothing or an accessory, or it rotates freely about an axis that is usually perpendicular to the plane defined by the face of the ornament. Examples of the former include many buttons such as described in U.S. Pat. No. 4,607,415 to Fukuroi and U.S. Pat. No. 3,028,6465 to Janes. Examples of the latter include U.S. Pat. No. 6,058,573 to Silver, and U.S. Pat. No. 5,308,671 to Wells. Unfortunately, none of these approaches allows the wearer to select a particular rotation about a central axis, thus limiting the options for display. The present invention meets these and other needs.

### 3 SUMMARY OF EMBODIMENTS OF THE INVENTION

In one embodiment, the present invention provides rotationally adjustable display device. In some embodiments, the device provided by the invention comprises a base plate that includes an interior face, an exterior face, and a channel extending through the interior and exterior faces. The device further comprises a locking disk that includes a flange, which flange includes an interior face, an exterior face, and a securing post extending substantially perpendicularly therefrom. The securing post is dimensioned to pass through the channel of the base plate. The device further includes a display element having an outer face and an inner face. A rotation selection post extending substantially perpendicularly from the inner face and has an outer surface including a series of facing surfaces and an inner channel dimensioned to accept and engage the securing post. The device further comprises a rotation selection plate including an interior face, an exterior face, and a aperture extending therethrough. The aperture of the rotation selection plate is dimensioned to receive the securing post and the rotation selection post and is further dimensioned such that the edges of the aperture engage the outer surfaces of the rotation selection post such that the display element is substantially rotationally secured when the rotation selection post is substantially engaged with the aperture and the edges of the aperture. Thus, the locking disk, the rotation plate, the display element, and the base plate are substantially immobilized when the securing post is engaged with the inner channel of the rotation selection post.

In some embodiments, the device further comprises at least one additional rotation selection plate.

In still other embodiments, the outer surface of the selection post is substantially hexagonal. In yet other embodiments, the outer surface of the selection post is substantially pentagonal. In still other embodiments, the outer surface of the selection post is substantially square. In yet still other embodiments, the outer surface of the selection post is substantially trigonal.

In another aspect, the present invention provides an article of clothing, comprising the above-described display device. In more specific embodiments, the article of clothing is a piece of outerwear. In other more specific embodiments, the article of clothing is a belt or strap; and, in still more specific embodiments, footwear.

In another aspect, the present invention provides a display device comprising a display element having an outer face, an inner face, and an rotation selection post extending substantially perpendicularly from the inner face. The rotation selection post includes an outer surface including a series of facing surfaces. The device also comprises a rotation selection plate including an interior face, an exterior face, and a aperture extending therethrough, the aperture dimensioned to receive the rotation selection post and further dimensioned such that the edges of the aperture engage the outer surfaces of the rotation selection post such that the display element is substantially rotationally secured when the rotation selection post is substantially engaged with the aperture and the edges of the aperture, such that the display element is substantially immobilized when engaged with the rotation plate.

In some embodiments, the above-described display device further comprises at least one spacer.

In still other embodiments, the outer surface of the selection post is substantially hexagonal. In yet other embodiments, the outer surface of the selection post is substantially pentagonal. In still other embodiments, the outer surface of the selection post is substantially square. In yet still other embodiments, the outer surface of the selection post is substantially trigonal.

In another aspect, the present invention provides an article of clothing, comprising the above-described display device. In more specific embodiments, the article of clothing is a piece of outerwear. In other more specific embodiments, the article of clothing is a belt or strap; and, in still more specific embodiments, footwear.

These and still more aspects and advantages will be apparent when the following Detailed Description is read in conjunction with the Drawings and Claims.

### BRIEF DESCRIPTION OF THE DRAWINGS

Exemplary embodiments of the present invention are described herein with reference to the following drawings, in which:

FIG. 1 is an oblique exterior view of a display device in accordance with one embodiment of the present invention.

FIG. 2A and FIG. 2B are facing view of two orientations of a display device in accordance with one aspect of the present invention. FIG. 2A shows a first rotational orientation of a star with one vertex pointing upwards. FIG. 2B shows a second rotational orientation in which the star is rotated 60 degrees.

FIG. 3 is an exploded view of a display device in accordance with one embodiment of the present invention.

FIG. 4A and FIG. 4B are two views of display element 30 of FIG. 3. FIG. 4A shows a side view of display element 30. FIG. 4B shows the view along line A-A of FIG. 4A.

FIG. 5 is a top-down view of a display device in accordance with the present invention in a closed configuration.

FIG. 6 is a top-down, exploded, cut away view of a display device in accordance with the present invention.

### 5 DETAILED DESCRIPTION OF SOME EMBODIMENTS OF THE INVENTION

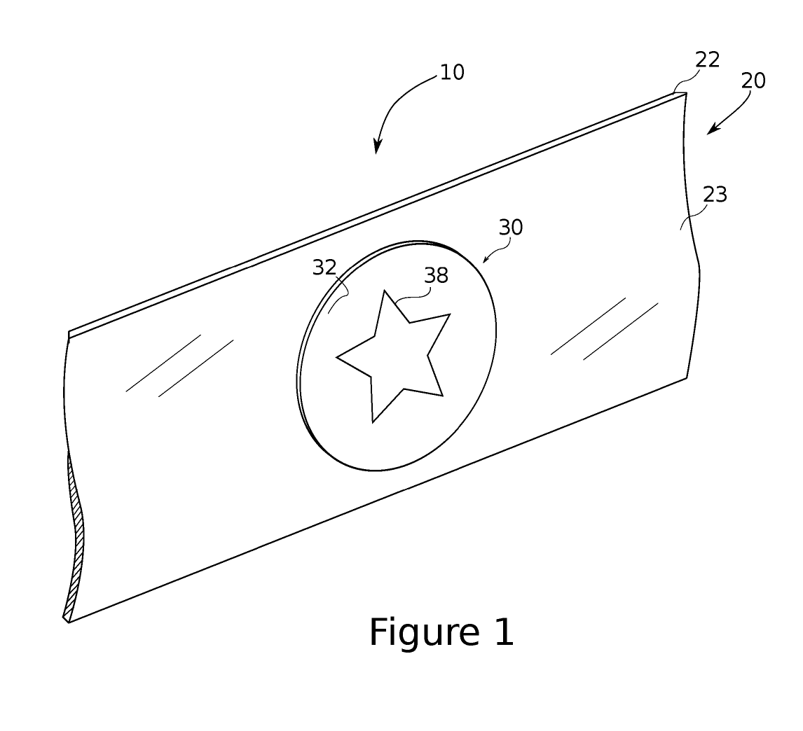

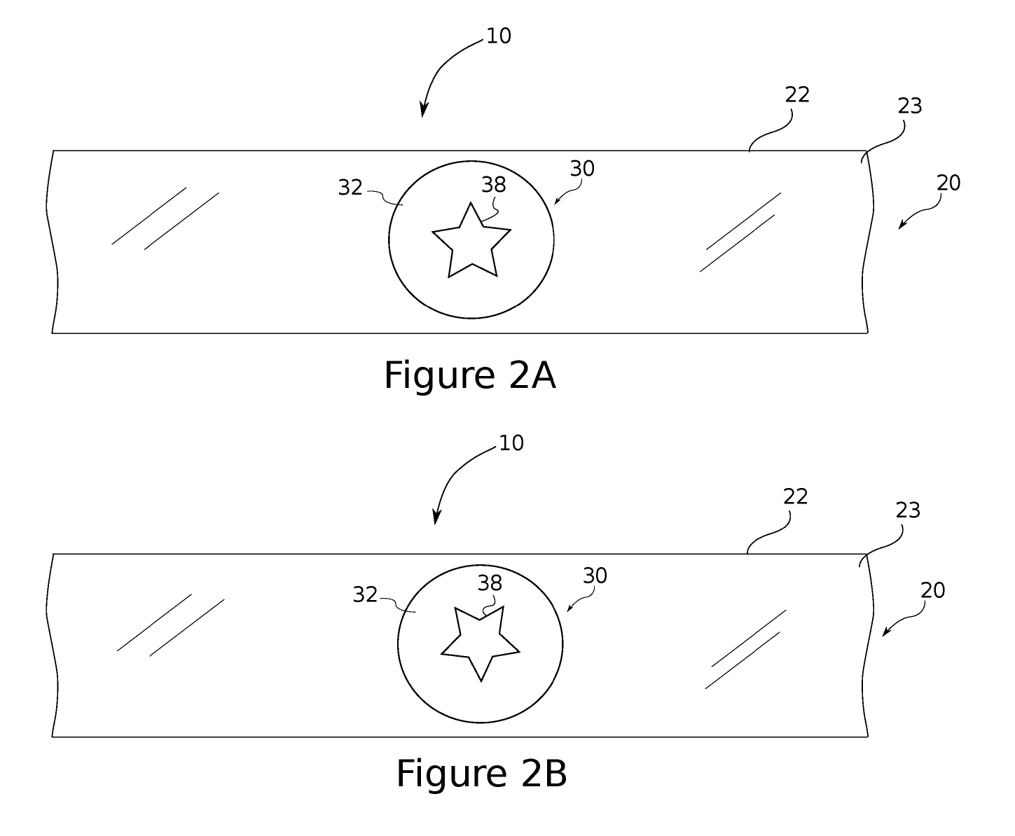

FIG. 1 shows an illustration of one embodiment of the invention at 10, including article of clothing or outerwear and a display device in accordance with one embodiment of the present invention 20. In the Figure, a support 22, such as a surface (typically visible) of an article of clothing (e.g., a shirt, jacket, trousers, coat, vest, or the like), an accessory (e.g., a belt, hat, strap, shoe, or the like), or a container (e.g., a box, handbag, backpack, “fanny pack”, lunch box, suitcase, or the like) holds a display element 30 including an outer face 32 and a display FIG. 38 on the exterior surface 23 of the support (20). In some embodiments, support 22 is a single layer, e.g., the cloth of a shirt or a leather flap of a handbag. In other embodiments, the support comprises two or more layers of material. In still other embodiments, the support is a panel that can be mounted on another material or connected to one or more panels. Still other arrangements and the choice of materials and their fabrication in accordance with the invention will be understood by those having ordinary skill in the art. Display element 30 will be described in greater detail below. Display FIG. 38 can be any design or ornamentation, including, but not limited to, gem stones (real or simulated), ceramics, glass, metal, printed images, and combinations thereof or the like. Those having ordinary skill in the art are familiar with the Techniques and materials necessary to create such display figures in accordance with the present invention. FIGS. 2A and 2B illustrate the operation of the present invention. FIG. 2A illustrates the display device 30 in a first rotational orientation. Using the methods and devices described herein, display device 30 is rotated into a second rotational orientation shown in FIG. 2B. Thus, using the devices and methods provided by the present invention, a wearer or user of the invention can readily change the configuration of a display (e.g., a piece or jewelry or ornament) to achieve multiple aesthetic effects or convey multiple meanings from a single display. Moreover, those having ordinary skill in the art will understand that the display devices of the invention are readily interchangeable to provide a variety of effects.

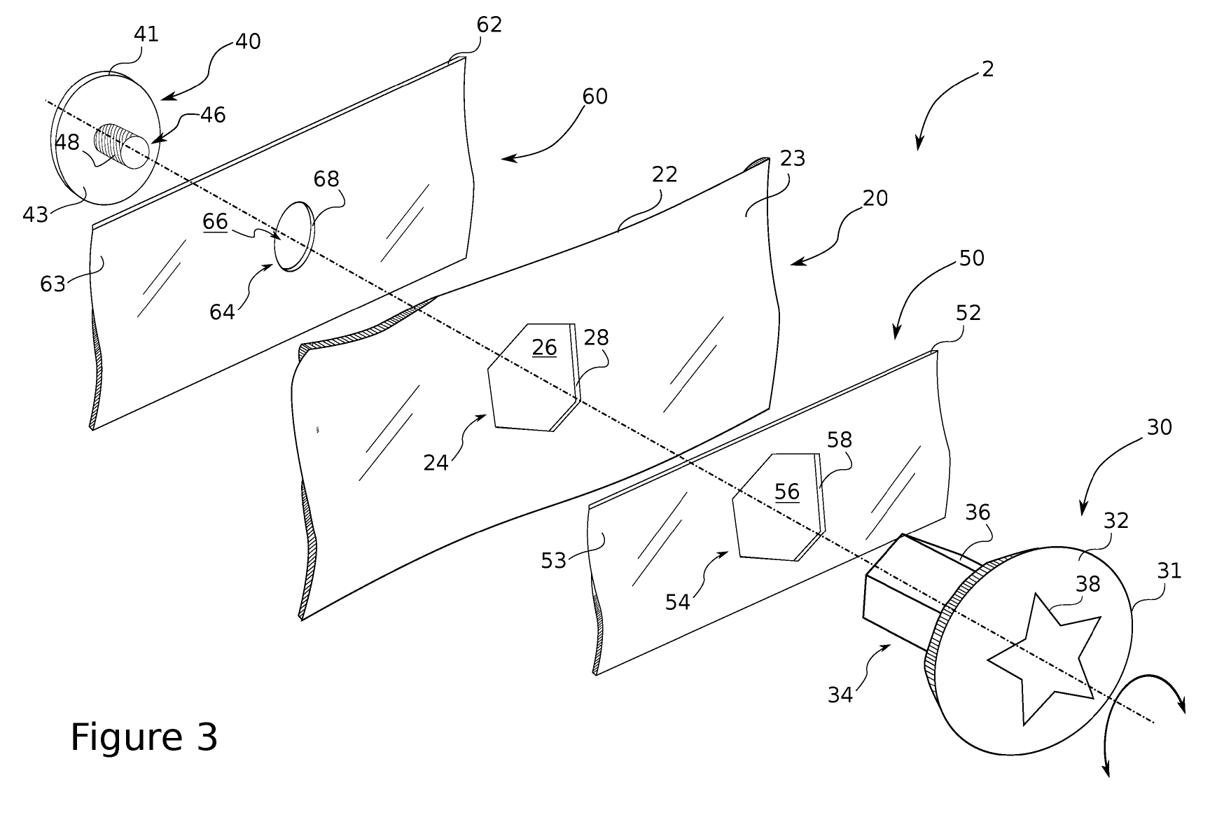

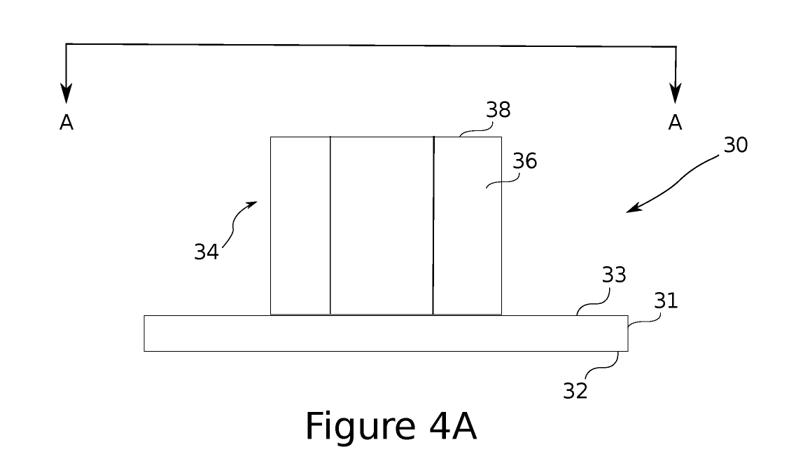

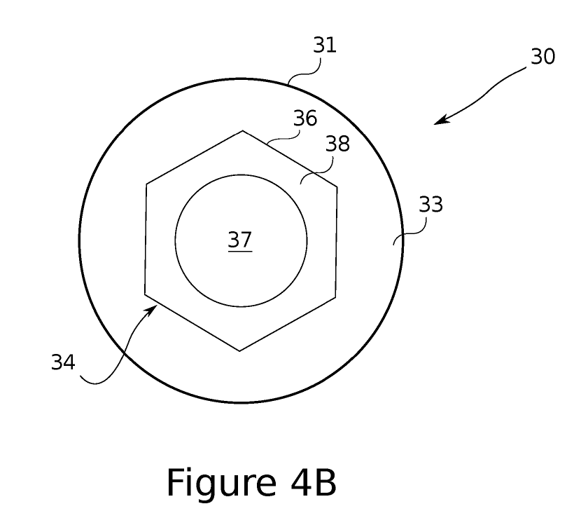

FIG. 3 illustrates the elements of one embodiment of the present invention and their relationships at 2. Display device 30 includes a display element 31, the exterior of which includes outer face 32 and display FIG. 38 as described generally above. As shown in FIG. 4A, display device 30 also includes an inner face 33. Extending substantially perpendicularly from the inner face is an orientation selection post 34. In one embodiment, the orientation selection post includes a series of facing surfaces 36 and an engagement surface 38 the functions of which function as described below. A more specific embodiment of display device 30 is illustrated in FIG. 4B. There, orientation election post 34 has a substantially hexagonal cross section and an inner channel 37 dimensioned to accept a securing post (not shown) as described below. The provision of locking disk 30 and its components is within the scope of skills of anyone of ordinary skill in the art.

Returning to FIG. 3, the present invention further includes a locking disk 40, including a flange or base 41 having an exterior surface 43 from which extends substantially perpendicularly securing post 46 dimensioned to engage with inner channel 37 as mentioned above. In one embodiment securing post 46 is threaded, with the threads 48 arranged and dimensioned to engage with a complementary set of threads provided on the surface of inner channel 37. The provision of locking disk 40 and its components is within the scope of skills of anyone of ordinary skill in the art.

In one embodiment, securing post 46 is dimensioned to traverse a channel or opening 66 defining an aperture 64 having an aperture surface 68, extending through base plate 62, all of which comprise a base 60, having an exterior surface 63, which exterior surface abuts interior surface 25 of support 22. In some embodiments, the aperture surface 68 is configured to engage with securing post 46 so that the latter can traverse aperture 64 when and advanced and rotated in a screwing motion. Securing post 46 also traverses an aperture 26 in support 22. Aperture 26 and its interior surface 28 are substantially identical to aperture 56 and surface 58 as described below. Base plate 62 can include one or more devices for preventing or limiting the rotation of base plate 62 relative to support 22, such as cleats or hooks, or base plate 62 can be integrated with support 22. Still more configurations for preventing or limiting such rotation will be apparent to those having ordinary skill in the art. Base plate 62 is typically dimensioned to be covered by support 22, but it can be of similar or even larger dimensions if desired, and is made from materials that provide a desired degree of strength for supporting the elements of the invention and their interactions as described herein. The choice of suitable materials and the fabrication of base 60 will be apparent to those having ordinary skill in the art.

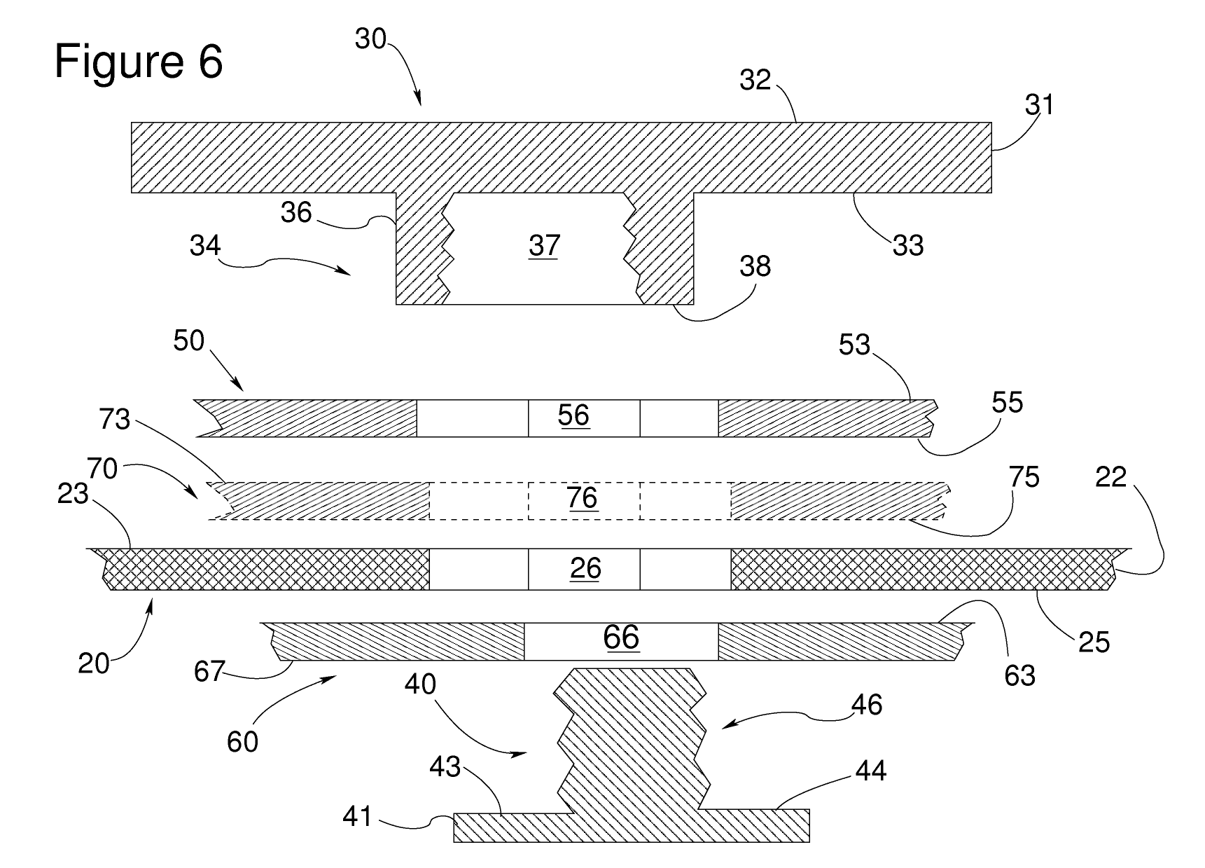

One embodiment of the invention includes an orientation selection element 50 that includes an orientation selection plate 52 having an exterior surface 58 and an interior surface 55 (see FIG. 6) that substantially abuts the exterior face (23) of support 22. Orientation selection plate 52 also includes an orientation selector 54 including an aperture 56 having a series of edges or internal surfaces 58. In one embodiment, the aperture and edges or internal surfaces are dimensioned to receive orientation selection post 34 such that the edges or internal surfaces engage with the facing surfaces (36) of the orientation selection post 34 to thereby prevent or retard any substantial rotation of display element 30 when the securing post engages inner channel 37, for example when securing post 46 is screwed into inner channel 37. Orientation selection post 34 and aperture 56 can be any suitable polygonal shape, including, but not limited to, triangular, square or rhombic, and pentagonal in addition to the illustrated hexagonal shape. Orientation selection plate 52 can include one or more devices for preventing or limiting the rotation of orientation selection plate 52 relative to support 22, such as cleats, hooks, snaps, tongue-and-groove arrangements or the like. Still more configurations for preventing or limiting such rotation will be apparent to those having ordinary skill in the art. Orientation selection plate 52 is typically dimensioned to be covered by display element 30, but it can be or similar or even larger dimensions if desired, and is made from materials that provide a desired degree of strength for supporting the elements of the invention and their interactions as described herein. The choice of suitable materials and the fabrication of orientation selection element 50 will be apparent to those having ordinary skill in the art.

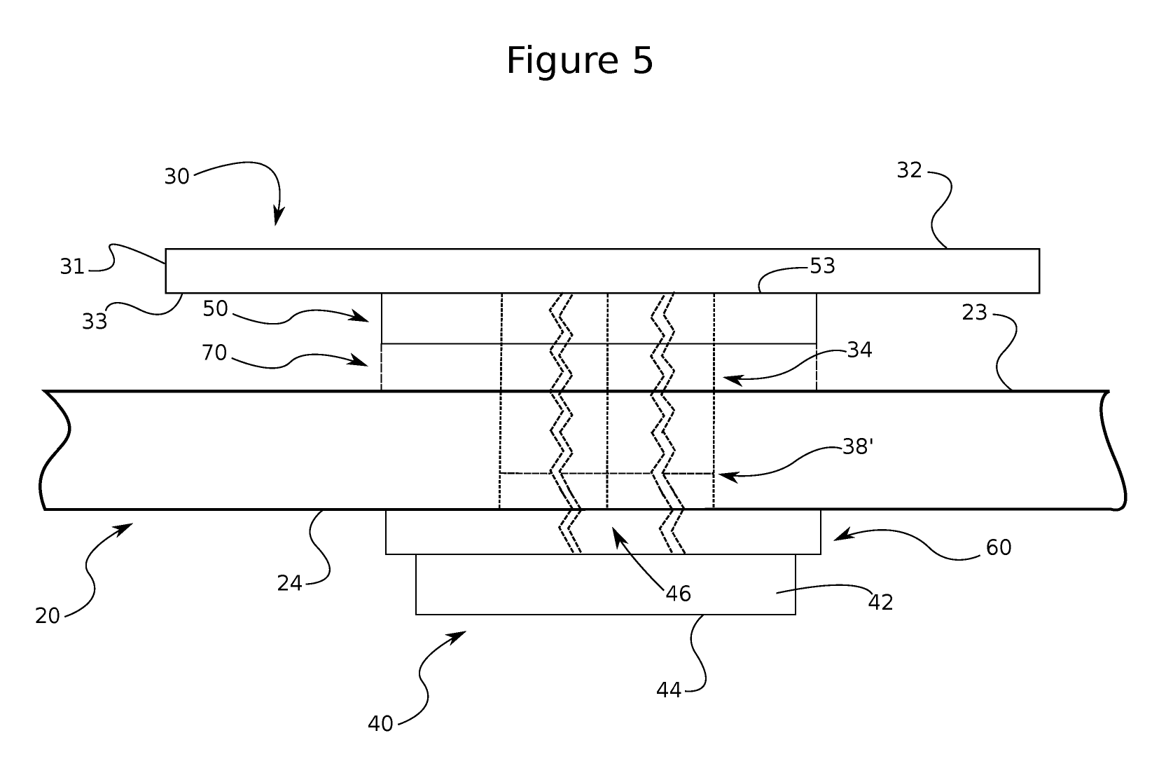

In one embodiment, orientation selection post 34 is dimensioned such that the diameter of inner channel 37 is substantially identical to channel 66, thus requiring surface 38 to abut exterior face 63 as illustrated by the dashed lines in FIG. 5. As illustrated in FIG. 5, the traversal of securing post 46 through apertures 66, 26, and 56 (and optionally with 76 as described below), and the engagement of its threads with those of inner channel 37, pulls locking disk 40, support 22, base plate 62, orientation selection plate 52, and display device 30 into mutual abutment to secure display device 30 from any substantial rotation. Moreover, the placement of support 22 between base plate 62 and orientation selection plate 52 prevents substantial wrinkling or warping of support 22. Disengagement of the securing post by unscrewing the securing post from the inner channel of the orientation selection post allows for rotation of the display device relative to the aperture of the orientation selection plate such that re-engagement of the securing post with the inner channel of the orientation selection post substantially locks the new orientation in place.

Both FIG. 5 and FIG. 6 also illustrate an alternate embodiment of the invention including an optional spacer 70 that in some embodiments is similar in size and configuration to orientation selection element 50, including exterior face 73, interior face 75, and aperture 76 (see FIG. 6). Additional embodiments include two or still more such spacers. Such spacers can be useful when support 22 is made from relatively thin or soft material. Still other conditions in which one or more such spacers are useful will be apparent to those having ordinary skill in the art. In some such embodiments, the spacer or spacers are placed intermediate support 22 and orientation selection plate 52 such that interior face 75 abuts the exterior face 23 of support 22, and exterior face 73 abuts interior face 55 of base plate 52. Generally, the addition of spacers will create a gap between surfaces 38 and 63 as shown at 38′, but those having ordinary skill in the will understand that the compression created by base plate 60 and spacer 70 caused by the engagement of the threads of securing post 46 with the interior of channel 37 will hold the assembly together as described above.

In some embodiments the spacer(s) are held to orientation plate 52 and each other (if more than one spacer is used) by the compression created when the securing post is engaged with the orientation selection post as described above. In other embodiments the spacer(s) are secured to the orientation plate by direct mechanism, such as, but not limited to, screws, pins, clips, magnetization and the like. Still more methods for securing the spacer(s) with the orientation selection plate will be apparent to those having ordinary skill in the art. In still other embodiments, orientation selection plate is dimensioned to provide the effect produced by a combination of the orientation plate and one or more spacers. In still other embodiments including one or more spacers as just described, the general configuration of display element 30, and more particularly outer face 32 is convex to a degree that the circumferential edge of outer face 32 substantially obscures orientation selection plate 52 and any spacers from the view of an observer. In other embodiments, outer face 32 includes a lip, which in some more particular embodiments is convex, to obstruct the sight of the spacers and orientation selection plate. Still more methods for providing a desired view will be apparent to those having ordinary skill in the art.

Still other embodiments include any of the above-described configurations and a retaining clip or other mechanism for preventing the separation of the locking disk 40 from base plate 62 if display device 30 is disengaged (e.g., unscrewed) from the assembled elements. The configuration of such a retaining clip or similar mechanism, or alternate mechanisms to achieve the same result, will be apparent to those having ordinary skill in the art.

In another aspect, the present invention provides a container comprising one or more of the above-described embodiments of the display device of the invention. As used herein, “container” means any device or object for holding other objects, including stationary and portable devices or objects for holding other objects. In more specific embodiments the container of the invention includes “luggage”, i.e., devices to hold objects that are portable by individuals. Non-limiting illustrative examples of such devices include, but are not limited to: suitcases, instrument cases, purses, shoulder bags, backpacks, brief cases, lunch boxes and the like. Such containers provided by the invention will include one or more surfaces, for example exterior surfaces, that comprise support 22 to which one or more display devices as described herein are attached. The materials and construction of such carriers is within the scope of those having ordinary skill in the art using the disclosure provided herein.

The above description of the embodiments, alternative embodiments, and specific examples, are given by way of illustration and should not be viewed as limiting. Further, many changes and modifications within the scope of the present embodiments may be made without departing from the spirit thereof, and the present invention includes such changes and modifications. Non-polygonal cross-sectional shapes for aperture 56 and orientation selection post 34 can be used as well. The display device can include illumination using batteries or another type of voltage supply. Multiple display devices can be used in combination to provide a desired combined visual or sensor effect. In addition, other methods and materials for engaging the display device and locking disk can be used, including for purpose of example and not limitation, magnets, snaps, and luer-type locks. All of the alternate embodiments can be fashioned by those having ordinary skill in the art.

What is claimed:

1. A rotationally adjustable display device, comprising:
a base (60) including a base plate (60), said base plate including an interior face (64), an exterior face (63), and a channel (66) extending through said base;
a locking disk (40) including a flange (41), said flange including an interior face (44), an exterior face (43), and a securing post (46) extending substantially perpendicularly from said exterior face, said securing post dimensioned to pass through said channel (66) of said base plate;
an display element (30) having an outer face (32), an inner face (34), and an rotation selection post (34) extending substantially perpendicularly from said inner face, said rotational selection post having an outer surface including a series of facing surfaces (36) and an inner channel (37) dimensioned to accept and engage said securing post (46);
an orientation selection element (50) including an orientation selection plate (52), said orientation selection plate including an interior face (55), an exterior face (53), and a aperture (56) extending through said orientation selection element, said aperture dimensioned to receive said securing post (46) and said rotation selection post (34), said aperture being further dimensioned such that the edges (58) of said aperture engage the outer surfaces (36) of said rotation selection post such that said display element is substantially rotationally secured when said rotation selection post is substantially engaged with said aperture and said edges of said aperture;
wherein said locking disk, said rotation plate, said display element, and said base plate are substantially immobilized when said securing post is engaged with said inner channel of said rotation selection post.

2. The display device of claim 1, further comprising at least one additional rotation selection plate.

3. The display device of claim 1, wherein said outer surface of said selection post is substantially hexagonal.

4. The display device of claim 1, wherein said outer surface of said selection post is substantially pentagonal.

5. The display device of claim 1, wherein said outer surface of said selection post is substantially square.

6. The display device of claim 1, wherein said outer surface of said selection post is substantially trigonal.

7. An article of clothing, comprising the display device of claim 1.

8. The article of clothing of claim 7, wherein said article of clothing is a piece of outerwear.

9. The article of clothing of claim 7, wherein said article of clothing is a belt or strap.

10. The article of clothing of claim 7, wherein said article of clothing is footwear.

11. A rotationally adjustable display device, comprising:
a display element (30) having an outer face (32), an inner face (34), and an rotation selection post (34) extending substantially perpendicularly from said inner face, said rotation selection post having an outer surface including a series of facing surfaces (36); and
an orientation selection plate (50) including an interior face (55), an exterior face (53), and a aperture (56) extending therethrough, said aperture dimensioned to receive said rotation selection post (34), said aperture being further dimensioned such that the edges (58) of said aperture engage the outer surfaces (36) of said rotation selection post such that said display element is substantially rotationally secured when said rotation selection post is substantially engaged with said aperture and said edges of said aperture;
wherein said display element is substantially immobilized when engaged with said rotation plate.

12. The display device of claim 11, further comprising at least one additional rotation selection plate.

13. The display device of claim 11, wherein said outer surface of said selection post is substantially hexagonal.

14. The display device of claim 11, wherein said outer surface of said selection post is substantially pentagonal.

15. The display device of claim 11, wherein said outer surface of said selection post is substantially square.

16. The display device of claim 11, wherein said outer surface of said selection post is substantially trigonal.

17. An article of clothing, comprising the display device of claim 11.

18. The article of clothing of claim 17, wherein said article of clothing is a piece of outerwear.

19. The article of clothing of claim 17, wherein said article of clothing is a belt or strap.

20. The article of clothing of claim 17, wherein said article of clothing is footwear.

21. An article of luggage, comprising the display device of claim 11.
